(19) United States
(12) Patent Application Publication
(10) Pub. No.: US 2006/0237559 A1
(43) Pub. Date: Oct. 26, 2006

(54) Sprinkler with sprinkling figures changeable with single hand

(76) Inventor: Gordon Chih, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/402,033

(22) Filed: Apr. 12, 2006

(30) Foreign Application Priority Data
Apr. 25, 2005 (TW) 094206454

(51) Int. Cl. A62C 31/02; A62C 31/00; B05B 9/01

(52) U.S. Cl. 239/394; 239/390; 239/393; 239/436; 239/526

(57) ABSTRACT

A sprinkler with sprinkling figures changeable with single hand includes a main body, a sprinkling head and a driving unit. One end of the main body is formed with a water inlet, while the other end of the main body is formed with a water outlet. The sprinkling head is formed with multiple annularly arranged ducts for discharging water. The sprinkling head is rotatably connected with front end of the main body corresponding to the water outlet. A first end of any duct can be aligned with the water outlet. The driving unit is disposed between the main body and the sprinkling head, including a force application member and a first, a second and a third guide members. The first guide member is disposed on rear face of the sprinkling head. The force application member serves to drive the second guide member to reciprocally slide along the first guide member. The third guide member is disposed in the force application member serves to guide the second guide member to one-way angularly displace for driving the first guide member to one-way angularly displace. A user can pull the force application member with one finger to rotate the sprinkling head and change the sprinkling figure.

### BACKGROUND OF THE INVENTION

The present invention is related to a sprinkler with variable sprinkling figures, and more particularly to a sprinkler with sprinkling figures changeable with single hand.

FIGS. 1 and 2 show a conventional sprinkling gun capable of varying sprinkling figures. The sprinkling gun includes a main body 91 and a sprinkling head 92. One end of the main body 91 is formed with a water inlet 93, while the other end of the main body 91 is formed with a water outlet 94. The sprinkling head 92 is formed with multiple annularly arranged sprinkling openings and water ducts designed with various sprinkling figures. The ducts communicate with both faces of the sprinkling head 92. The sprinkling head 92 is rotatably connected with front end of the main body 91 corresponding to the water outlet 94. First ends of the ducts can be aligned with the water outlet 94 for receiving a water flow coming from the water outlet 94. When changing the sprinkling figure, a user must hold the handle of the sprinkling gun with one hand and turn the sprinkling head 92 with the other hand (as shown in FIG. 2). In other words, the user must use both hands to change the sprinkling figure. This is quite inconvenient and the hands of the user will be wetted. Furthermore, when it is desired to change the sprinkling figure, in the case that the user holds the sprinkling gun with one hand and holds a sponge or a brush with the other hand for washing an article, it is necessary for the user to drop the sponge or the brush and vacate one hand for turning the sprinkling head 92. This is also quite inconvenient.

### SUMMARY OF THE INVENTION

It is therefore a primary object of the present invention to provide a sprinkler with sprinkling figures changeable with single hand. A user can readily and conveniently turn the sprinkling head to change the sprinkling figures with single hand.

It is a further object of the present invention to provide the above sprinkler with sprinkling figures changeable with single hand. A user can turn the sprinkling head with little strength to change the sprinkling figures.

According to the above objects, the sprinkler with sprinkling figures changeable with single hand of the present invention includes a main body, a sprinkling head and a driving unit. One end of the main body is formed with a water inlet, while the other end of the main body is formed with a water outlet. The sprinkling head is formed with multiple annularly arranged ducts for discharging water. The sprinkling head is rotatably connected with front end of the main body corresponding to the water outlet. A first end of any duct can be aligned with the water outlet. The driving unit is disposed between the main body and the sprinkling head, including a force application member and a first, a second and a third guide members. The first guide member is disposed on rear face of the sprinkling head. The force application member serves to drive the second guide member to reciprocally slide along the first guide member. The third guide member is disposed in the force application member serves to guide the second guide member to one-way angularly displace for driving the first guide member to one-way angularly displace.

The present invention can be best understood through the following description and accompanying drawings wherein:

### BRIEF DESCRIPTION OF THE DRAWINGS

FIG. 1 is a perspective view of a conventional sprinkling gun with variable sprinkling figures;

FIG. 2 is a perspective view of the conventional sprinkling gun, showing the use thereof;

FIG. 3 is a perspective exploded view of the present invention;

FIG. 4 is a perspective exploded view of the present invention, seen in another direction;

FIG. 5 is a sectional assembled view of the present invention; and

FIG. 6 is a perspective view of the present invention, showing that a user changes the sprinkling figure with one finger of single hand.

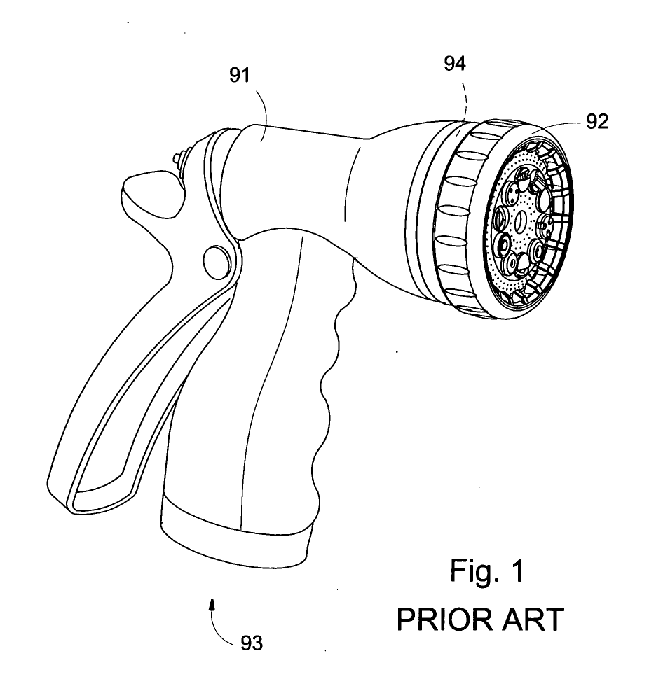

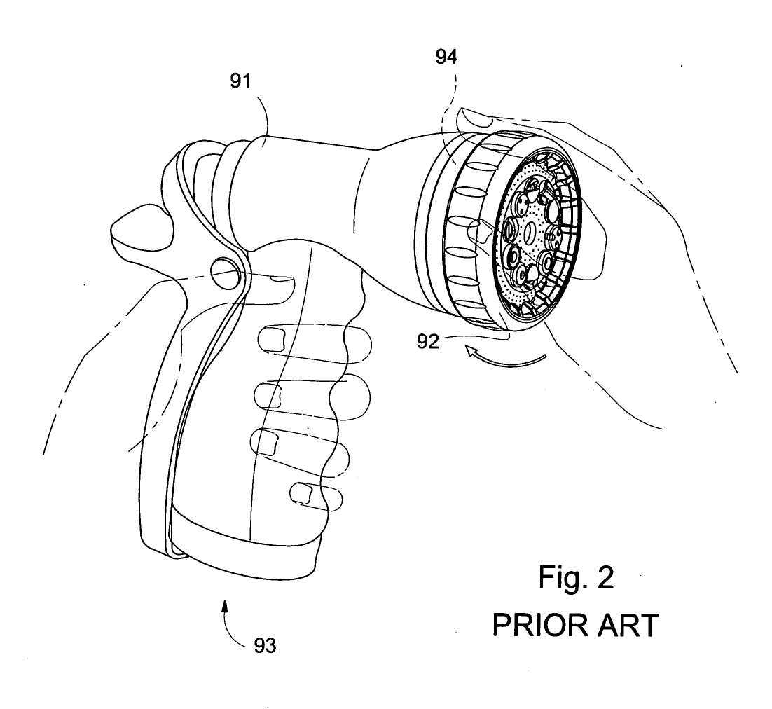

### DETAILED DESCRIPTION OF THE PREFERRED EMBODIMENTS

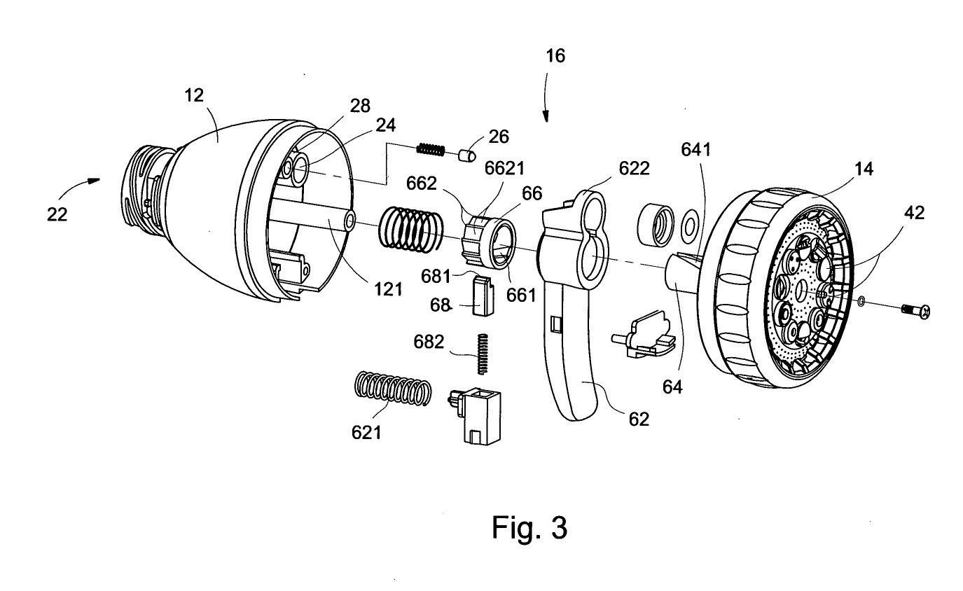

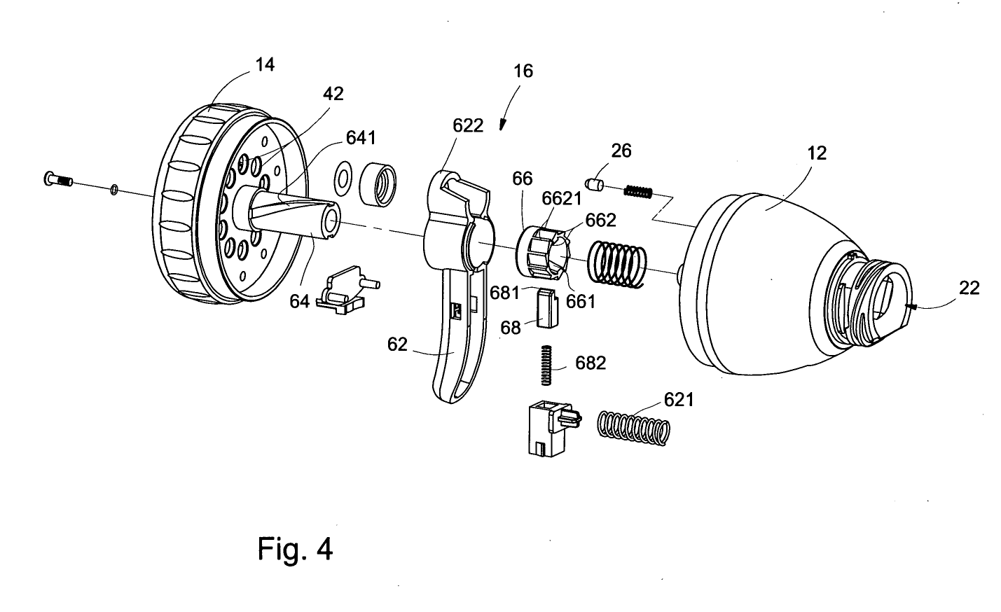

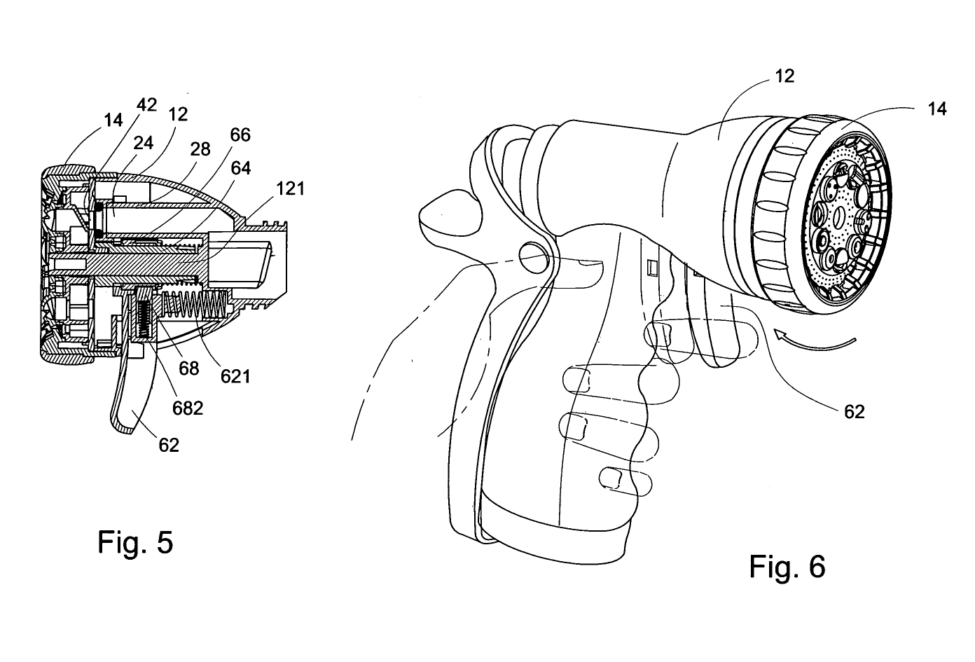

Please refer to FIGS. 3 to 6. The sprinkler of the present invention includes a main body 12, a sprinkling head 14 and a driving unit 16. One end of the main body 12 is formed with a water inlet 22, while the other end of the main body 12 is formed with a water outlet 24 from which a water flow outgoes. One face of the sprinkling head 14 is formed with multiple annularly arranged ducts 42 designed with various sprinkling figures. The ducts 42 communicate with two opposite sides of the sprinkling head 14. The sprinkling head 14 is rotatably connected with front end of the main body 12 corresponding to the water outlet 24. A first end of the duct 42 can be aligned with the water outlet 24 for receiving the water flow coming from the water outlet 24. The rotational axis of the sprinkling head 14 corresponds to the direction of the water flow. The sprinkling head 14 is connected with the main body 12 via a locating pin 26 which pertains to prior art.

The driving unit 16 is disposed between the main body 12 and the sprinkling head 14, including at least one force application member 62 and a driven section. The force application member 62 is movable between the main body 12 and the sprinkling head 14. The driven section is positioned between the sprinkling head 14 and the force application member 62. The force application member 62 serves to drive the driven section to drive and one-way rotate the sprinkling head 14.

The driven section includes a first guide member 64, a second guide member 66 and a third guide member 68.

The first guide member 64 is a cylindrical body extending from rear face of the sprinkling head 14 toward the main body 12 by a certain length. The outer circumference of the first guide member 64 is formed with a spiraled first slide section 641. The first slide section 641 can be a spiraled channel. The first guide member 64 can be a hollow cylindrical body fitted on a post body 121 forward protruding from the main body 12. A screw is fitted through the sprinkling head 14 and screwed into the post body 121 to rotatably connect the sprinkling head 14 with the main body 12.

The second guide member 66 is a hollow cylindrical body fitted around the first guide member 64. The inner circumference of the second guide member 66 is formed with a second slide section 661 inlaid in the first slide section 641. The second slide section 661 can be a rib.

One end of the force application member 62 is formed with a cavity for receiving and connecting with the second guide member 66. The force application member 62 serves to drive the second guide member 66, whereby the second slide section 661 of the second guide member 66 can reciprocally slide along the first slide section 641 of the first guide member 64 between a first position and a second position.

The third guide member 68 is disposed in the force application member 62. A first end of the third guide member 68 is engaged with the second guide member 66, whereby when the second guide member 66 is moved from the first position to the second position, the third guide member 68 enables the second guide member 66 to drive and rotate the first guide member 64 without angularly displacing. At this time, the sprinkling head 14 is driven and rotated. On the other hand, when the second guide member 66 is moved from the second position to the first position, the third guide member 68 permits the second guide member 66 to angularly displace without driving and rotating the first guide member 64. The outer circumference of the second guide member 66 is formed with multiple annularly arranged teeth 662 radially projecting from the second guide member 66. Each tooth 662 has a first guide slope 6621. The first end of the third guide member 68 is formed with a second guide slope 681. A coil spring 682 is disposed at the second end of the third guide member 68 for pushing the third guide member 68 into the space between two teeth 662 and making the second guide slope 681 abut against the first guide slope 6621. Accordingly, the third guide member 68 serves as a pawl only permitting the second guide member 66 to one-way angularly displace.

The sprinkler with sprinkling figures changeable with single hand of the present invention has the following advantages:
1. The force application member 62 is positioned between the main body 12 and the sprinkling head 14. When it is desired to change the sprinkling figure, a user only needs to pull the force application member 62 with one finger of one hand. At this time, the sprinkling head 14 is readily and conveniently turned to vary the sprinkling figure.
2. The outer circumference of the first guide member 64 is formed with a spiraled first slide section 641, while the inner circumference of the second guide member 66 is formed with a second slide section 661 inlaid in the first slide section 641. A user can pull the force application member 62 with little strength to drive the sprinkling head 14 for changing the sprinkling figure.
3. The second slide section 661 of the second guide member 66 is slidable along the first slide section 641 of the first guide member 64, whereby the user can smoothly pull the force application member 62 with one finger of one hand to truly change the sprinkling figure. In other words, when the force application member 62 is moved toward the main body 12 (from the first position to the second position), the sprinkling head 14 is driven and rotated.

In the above structure, a coiled spring 621 is further disposed between the force application member 62 and the main body 12 for restoring the force application member 62 to the first position. The coiled spring 621 also helps the second guide member 66 in reciprocally moving between the first and second positions.

The force application member 62 further includes a first connecting section 622 such as a tubular fitting member. The main body 12 has a second connecting section 28 beside the water outlet 24. The first connecting section 622 is fitted with the second connecting section 28 to more firmly assemble the force application member 62 with the main body 12.

In the case that the main body 12 is an elongated rod body, a tube body with a certain length is disposed between the water inlet 22 and the water outlet 24 to communicate the water inlet 22 with the water outlet 24. Under such circumstance, the force application member 62 includes a steel cord with a certain length. One end of the steel cord is connected with a second end of the force application member 62, while the other end of the steel cord extends along the tube body to lower end of the main body 12, where a handle is disposed near the water inlet 22. A user can pull the steel cord with a finger of single hand to remotely operate the sprinkling head 14 to one-way rotate.

The above embodiments are only used to illustrate the present invention, not intended to limit the scope thereof. Many modifications of the above embodiments can be made without departing from the spirit of the present invention.

What is claimed is:

1. A sprinkler with sprinkling figures changeable with single hand, comprising:
a main body, one end of the main body being formed with a water inlet, while the other end of the main body being formed with a water outlet from which a water flow outgoes; and
a sprinkling head, one face of the sprinkling head being formed with multiple annularly arranged ducts designed with various sprinkling figures, the ducts communicating with two opposite sides of the sprinkling head, the sprinkling head being rotatably connected with front end of the main body corresponding to the water outlet, whereby a first end of any duct can be aligned with the water outlet for receiving the water flow coming from the water outlet, a rotational axis of the sprinkling head corresponding to a direction of the water flow, said sprinkler being characterized in that the sprinkler further comprises a driving unit disposed between the main body and the sprinkling head, the driving unit including at least one force application member and a driven section, the force application member being movable between the main body and the sprinkling head, the driven section being positioned between the sprinkling head and the force application member, the force application member serving to drive the driven section to drive and one-way rotate the sprinkling head.

2. The sprinkler with sprinkling figures changeable with single hand as claimed in claim 1, wherein the driven section includes a first guide member, a second guide member and a third guide member, the first guide member being a cylindrical body extending from rear face of the sprinkling head toward the main body by a certain length, an outer circumference of the first guide member being formed with a spiraled first slide section, the second guide member being a hollow cylindrical body fitted around the first guide member, an inner circumference of the second guide member being formed with a second slide section inlaid in the first slide section, one end of the force application member being connected with the second guide member to drive the second guide member, whereby the second slide section of the second guide member can reciprocally slide along the first slide section of the first guide member between a first position and a second position, the third guide member being disposed in the force application member, a first end of the third guide member being engaged with the second guide member, whereby when the second guide member is moved from the first position to the second position, the third guide member enables the second guide member to drive and rotate the first guide member without angularly displacing so as to drive and rotate the sprinkling head, when the second guide member is moved from the second position to the first position, the third guide member permitting the second guide member to angularly displace without driving and rotating the first guide member.

3. The sprinkler with sprinkling figures changeable with single hand as claimed in claim 2, wherein one end of the force application member is formed with a cavity for receiving the second guide member.

4. The sprinkler with sprinkling figures changeable with single hand as claimed in claim 2, wherein the first slide section is a channel, while the second slide section is a rib.

5. The sprinkler with sprinkling figures changeable with single hand as claimed in claim 2, wherein an outer circumference of the second guide member is formed with multiple annularly arranged teeth radially projecting from the second guide member, each tooth having a first guide slope, the first end of the third guide member being formed with a second guide slope, a resilient member being disposed at the second end of the third guide member for pushing the third guide member into a space between two teeth and making the second guide slope abut against the first guide slope, whereby the third guide member only permits the second guide member to one-way angularly displace.

6. The sprinkler with sprinkling figures changeable with single hand as claimed in claim 3, wherein an outer circumference of the second guide member is formed with multiple annularly arranged teeth radially projecting from the second guide member, each tooth having a first guide slope, the first end of the third guide member being formed with a second guide slope, a resilient member being disposed at the second end of the third guide member for pushing the third guide member into a space between two teeth and making the second guide slope abut against the first guide slope, whereby the third guide member only permits the second guide member to one-way angularly displace.

7. The sprinkler with sprinkling figures changeable with single hand as claimed in claim 4, wherein an outer circumference of the second guide member is formed with multiple annularly arranged teeth radially projecting from the second guide member, each tooth having a first guide slope, the first end of the third guide member being formed with a second guide slope, a resilient member being disposed at the second end of the third guide member for pushing the third guide member into a space between two teeth and making the second guide slope abut against the first guide slope, whereby the third guide member only permits the second guide member to one-way angularly displace.

8. The sprinkler with sprinkling figures changeable with single hand as claimed in claim 2, wherein a resilient member is further disposed between the force application member and the main body for helping the second guide member in reciprocally moving between the first and second positions.

9. The sprinkler with sprinkling figures changeable with single hand as claimed in claim 3, wherein a resilient member is further disposed between the force application member and the main body for helping the second guide member in reciprocally moving between the first and second positions.

10. The sprinkler with sprinkling figures changeable with single hand as claimed in claim 4, wherein a resilient member is further disposed between the force application member and the main body for helping the second guide member in reciprocally moving between the first and second positions.

11. The sprinkler with sprinkling figures changeable with single hand as claimed in claim 5, wherein a resilient member is further disposed between the force application member and the main body for helping the second guide member in reciprocally moving between the first and second positions.

12. The sprinkler with sprinkling figures changeable with single hand as claimed in claim 6, wherein a resilient member is further disposed between the force application member and the main body for helping the second guide member in reciprocally moving between the first and second positions.

13. The sprinkler with sprinkling figures changeable with single hand as claimed in claim 7, wherein a resilient member is further disposed between the force application member and the main body for helping the second guide member in reciprocally moving between the first and second positions.

14. The sprinkler with sprinkling figures changeable with single hand as claimed in claim 2, wherein the force application member further includes a first connecting section and the main body has a second connecting section, the first connecting section being fitted with the second connecting section to more firmly assemble the force application member with the main body.

15. The sprinkler with sprinkling figures changeable with single hand as claimed in claim 3, wherein the force application member further includes a first connecting section and the main body has a second connecting section, the first connecting section being fitted with the second connecting section to more firmly assemble the force application member with the main body.

16. The sprinkler with sprinkling figures changeable with single hand as claimed in claim 4, wherein the force application member further includes a first connecting section and the main body has a second connecting section, the first connecting section being fitted with the second connecting section to more firmly assemble the force application member with the main body.

17. The sprinkler with sprinkling figures changeable with single hand as claimed in claim 5, wherein the force application member further includes a first connecting section and the main body has a second connecting section, the first connecting section being fitted with the second connecting section to more firmly assemble the force application member with the main body.

18. The sprinkler with sprinkling figures changeable with single hand as claimed in claim 6, wherein the force application member further includes a first connecting section and the main body has a second connecting section, the first connecting section being fitted with the second connecting section to more firmly assemble the force application member with the main body.

19. The sprinkler with sprinkling figures changeable with single hand as claimed in claim 7, wherein the force application member further includes a first connecting section and the main body has a second connecting section, the first connecting section being fitted with the second connecting section to more firmly assemble the force application member with the main body.
